(19) United States
(12) Patent Application Publication
(10) Pub. No.: US 2024/0246036 A1
(43) Pub. Date: Jul. 25, 2024

(54) ANTIFOULING MEMBRANES, FILTRATION SYSTEMS, AND RELATED ASPECTS FOR CONTINUOUS MOLECULAR HARVESTING AND OTHER APPLICATIONS

(71) Applicant: THE JOHNS HOPKINS UNIVERSITY, Baltimore, MD (US)

(72) Inventors: Honggang CUI, Lutherville-Timonium, MD (US); Boran SUN, Baltimore, MD (US); Michael J. BETENBAUGH, Baltimore, MD (US); David STERN, Baltimore, MD (US)

(21) Appl. No.: 18/413,529

(22) Filed: Jan. 16, 2024

Related U.S. Application Data
(60) Provisional application No. 63/480,540, filed on Jan. 19, 2023.

(51) Int. Cl. B01D 65/08; B01D 69/12; B01D 71/68

(52) U.S. Cl. CPC B01D 65/08; B01D 69/12; B01D 71/68; B01D 2311/2523; B01D 2325/48

(57) ABSTRACT

Provided herein are antifouling filtration membranes that include a membrane substrate and an antifouling coating disposed on at least one surface of the membrane substrate. The antifouling coating comprises a plurality of zwitterionic molecules or moieties at a density sufficient to form a hydration shell when an aqueous input composition contacts the antifouling coating. The hydration shell substantially prevents fouling components in the aqueous input composition from adsorbing on the membrane substrate while substantially permitting target permeate molecules in the aqueous input composition to flow through the membrane substrate. Additional methods and related devices, systems, and kits are also provided.

### CROSS-REFERENCE TO RELATED APPLICATIONS

This application claims priority to U.S. Provisional Patent Application Ser. No. 63/480,540, filed Jan. 19, 2023, the disclosure of which is incorporated herein by reference.

### STATEMENT REGARDING FEDERALLY SPONSORED RESEARCH OR DEVELOPMENT

This invention was made with government support under grant #1624684 and #2100800 awarded by the National Science Foundation. The government has certain rights in the invention.

### BACKGROUND

Membrane fouling by cellular debris has become an increasingly important issue in the design and implementation of a tangential flow filtration process, hampering the consistent separation of target products from cultured mammalian cells. While strategies that evaluate cellular behaviors could slow down the membrane fouling process, they do not present an ultimate solution and could potentially complicate the production and yield of the target proteins.

Accordingly, there is a need for additional methods, and related aspects, for minimizing membrane fouling during tangential flow filtration processes, among other purification applications.

### SUMMARY

The present disclosure relates, in certain aspects, to antifouling membranes, methods, devices, kits, and systems, of use, for example, in minimizing membrane fouling during protein or other target molecule purification processes, including the separation of protein therapeutics from cells or cell harvests. In some embodiments, for example, the present disclosure provides filtration membranes with a peptide-based antifouling surface that can effectively limit the adsorption of cellular debris. In some embodiments, the present disclosure provides effective membrane filtration systems coated with a robust antifouling material for continuous protein harvesting at industrial levels. These and other aspects will be apparent upon a complete review of the present disclosure, including the accompanying figures.

In one aspect, the present disclosure provides an antifouling filtration membrane that includes a membrane substrate. The antifouling filtration membrane also includes an antifouling coating disposed on at least one surface of the membrane substrate, in which the antifouling coating comprises a plurality of zwitterionic molecules or moieties at a density sufficient to form a hydration shell when an aqueous input composition contacts the antifouling coating and in which the hydration shell substantially prevents fouling components in the aqueous input composition from adsorbing on the membrane substrate (e.g., while substantially permitting target permeate molecules in the aqueous input composition to flow through the membrane substrate). In some embodiments, a device, a system, or a kit comprises the antifouling filtration membranes as disclosed herein.

In another aspect, the present disclosure provides a system that includes a filtration module that comprises an inlet port, an outlet port, and an antifouling filtration membrane, wherein the antifouling filtration membrane comprises: a membrane substrate, and an antifouling coating disposed on at least one surface of the membrane substrate, in which the antifouling coating comprises a plurality of zwitterionic molecules or moieties at a density sufficient to form a hydration shell when an aqueous input composition contacts the antifouling coating and which the hydration shell substantially prevents fouling components in the aqueous input composition from adsorbing on the membrane substrate (e.g., while substantially permitting target permeate molecules in the aqueous input composition to flow through the membrane substrate). The system also includes an storage container configured to contain the aqueous input composition, which storage container fluidly communicates with the inlet port of the filtration module, a retentate fluid circuit that fluidly communicates with the outlet port of the filtration module, and a fluid conveyance mechanism operably connected to the filtration module, the storage container, and/or the retentate fluid circuit. In addition, the system also includes a controller operably connected, or connectable, to the fluid conveyance mechanism, which controller comprises, or is capable of accessing, computer readable media comprising non-transitory computer-executable instructions, which when executed by at least one electronic processor perform at least: conveying the aqueous input composition into the filtration module through the inlet port from the storage container when the storage container contains the aqueous input composition. In some embodiments, the retentate fluid circuit further fluidly communicates with the storage container such that retentate from the aqueous input composition is conveyed back to the storage container from the outlet port when the aqueous input composition is conveyed into the filtration module through the inlet port.

In another aspect, the present disclosure provides a method of separating target permeate molecules from retentate molecules in an aqueous input composition. The method includes contacting the aqueous input composition with an antifouling filtration membrane that comprises a membrane substrate, and an antifouling coating disposed on at least one surface of the membrane substrate, in which the antifouling coating comprises a plurality of zwitterionic molecules or moieties at a density sufficient to form a hydration shell when the aqueous input composition contacts the antifouling coating, in which the hydration shell substantially prevents fouling components in the aqueous input composition from adsorbing on the membrane substrate while substantially permitting the target permeate molecules in the aqueous input composition to flow through the membrane substrate, and in which the antifouling filtration membrane substantially prevents the retentate molecules in the aqueous input composition from flowing through the membrane substrate, thereby separating the target permeate molecules from the retentate molecules in the aqueous input composition.

In another aspect, the present disclosure provides a method of producing an antifouling filtration membrane. The method includes coating at least one surface of a membrane substrate with an antifouling coating, in which the antifouling coating comprises a plurality of zwitterionic molecules or moieties at a density sufficient to form a hydration shell when an aqueous input composition contacts the antifouling coating and in which the hydration shell substantially prevents fouling components in the aqueous input composition from adsorbing on the membrane substrate while substantially permitting target permeate molecules in the aqueous input composition to flow through the membrane substrate, thereby producing the antifouling filtration membrane. In some embodiments, the method includes conjugating at least some of the plurality of zwitterionic molecules or moieties to the surface of the membrane substrate via one or more linker moieties. In some embodiments, the method includes conjugating dopamine methacrylamide to the surface of the membrane substrate. In some embodiments, the method includes conjugating the plurality of zwitterionic molecules or moieties to the dopamine methacrylamide. In some embodiments, the method includes conjugating the plurality of zwitterionic molecules or moieties to the dopamine methacrylamide via one or more anchor groups.

Various optional features of the above embodiments include the following. The zwitterionic molecules or moieties are zwitterionic molecules. The zwitterionic molecules or moieties are zwitterionic moieties. The antifouling filtration membrane is substantially non-cytotoxic. The membrane substrate comprises a porous membrane substrate. The membrane substrate comprises a membrane material selected from, for example, polyacrynitrile (PAN), poly(vinylidene fluoride) (PVDF), polysulfone (PSF), poly(ethersulfone) (PES), poly(glycidyl methacrylate) (PGMA), cellulose, cross-linked regenerated cellulose (xRC), cellulose acetate (CA), and combinations thereof. The zwitterionic molecules or moieties are molecules selected from, for example, polyethylene glycol (PEG), dextran, polyethylenimine (PEI), sulfobetaine methacrylate (SBMA), poly(methyl methacrylate (PMMA), sulfobetaine-2-vinyl pyridine (SB2VP), (3-(methacryloylamino)propyl)dimethyl (3-sulfopropyl)ammonium hydroxide (MPDSAH), hexafluorobutyl methacrylate (HFBM), N,N-dimethyl-N-methacryloxyethyl N-(3-sulfopropyl) ammonium betaine (DMMSA), 3-[[2-(methacryloyloxy)ethyl]dimethylammonio]propionate (CBMA), poly(2-methacryloyloxyethyl phosphorylcholine methacrylate) (PMPC), and combinations thereof. The zwitterionic molecules or moieties comprise at least one zwitterionic pair of amino acid residues. The zwitterionic molecules or moieties comprise biomolecules. The biomolecules comprise unmodified and/or modified amino acids, unmodified and/or modified nucleosides, unmodified and/or modified carbohydrates, and/or unmodified and/or modified lipids. At least one zwitterionic molecule or moiety in the plurality of zwitterionic molecules or moieties comprises at least one zwitterionic polyampholyte peptide. At least one zwitterionic molecule or moiety in the plurality of zwitterionic molecules or moieties comprises at least one non-natural amino acid residue. At least one zwitterionic molecule or moiety comprises a structure that is selected from the group consisting of: KE-8, MKE-12, and KE-12, as described further herein. The plurality of zwitterionic molecules or moieties comprises a plurality of zwitterionic peptides having a grafting density on the surface of the membrane substrate of at least about 0.05 chains/nm². The antifouling filtration membrane adsorbs less than about 1.5 μg of an IgG protein/cm² of the membrane substrate when the membrane substrate is exposed to the IgG protein. The aqueous input composition comprises a protein solution, a cell culture medium, and/or a lysed cell solution. The target permeate molecules comprise one or more target permeate biomolecules. The target permeate biomolecules comprise one or more target permeate protein molecules (e.g., therapeutic protein molecules). At least some of the plurality of zwitterionic molecules or moieties are covalently conjugated to the surface of the membrane substrate. At least some of the plurality of zwitterionic molecules or moieties are non-covalently conjugated to the surface of the membrane substrate. At least some of the plurality of zwitterionic molecules or moieties are conjugated to the surface of the membrane substrate via one or more linker moieties. Dopamine methacrylamide is conjugated to the surface of the membrane substrate. The plurality of zwitterionic molecules or moieties is conjugated to the dopamine methacrylamide. The plurality of zwitterionic molecules or moieties is conjugated to the dopamine methacrylamide via one or more anchor groups. The membrane substrate comprises poly(ethersulfone) (PES) and wherein the plurality of zwitterionic molecules or moieties comprise KE-12 structures. The KE-12 structures are conjugated to the membrane substrate via dopamine methacrylamide.

### BRIEF DESCRIPTION OF THE DRAWINGS

The accompanying drawings, which are incorporated in and constitute a part of this specification, illustrate certain embodiments, and together with the written description, serve to explain certain principles of the antifouling membranes, methods, devices, kits, systems, and related computer readable media disclosed herein. The description provided herein is better understood when read in conjunction with the accompanying drawings which are included by way of example and not by way of limitation. It will be understood that like reference numerals identify like components throughout the drawings, unless the context indicates otherwise. It will also be understood that some or all of the figures may be schematic representations for purposes of illustration and do not necessarily depict the actual relative sizes or locations of the elements shown.

FIG. 1 is a schematic diagram of an exemplary zwitterionic peptide antifouling mechanism according to some embodiments.

FIG. 2 shows exemplary zwitterionic peptide designs of varying length and linker type according to some embodiments.

FIG. 3 shows an exemplary chemical modification of a poly(ethersulfone) (PES) membrane according to some embodiments.

FIG. 4 is a schematic diagram of an exemplary system suitable for use with certain embodiments.

FIGS. 5A and 5B are illustrations of a zwitterionic peptide modified substrate and the design of the molecules. (A) Schematic of zwitterionic peptides modified substrate antifouling mechanism. (B) Chemical structure of four designed molecules. Three zwitterionic peptides (KE8, KE12, and MKE12) consisting of a different number of lysine and glutamic acid pairs with different linker designs. NZP is a control peptide with no zwitterionic characteristic consisting of an unequal number of lysine and glutamic acid residues.

FIGS. 6A-6G. Determining the antifouling performance of zwitterionic peptide modified gold chips. (A) antifouling performance measurement process of zwitterionic peptide modified gold chips including cell environment incubation, surface sonication and UV-Vis measurement. (B) IgG protein (1 mg/mL) adsorption per unit centimeter square which is determined by UV-Vis, (C) Day 0 cell culture media adsorption at 280 nm, (D) 7 days cell culture media adsorption at 280 nm, lysed cell culture media adsorption at (E) 280 nm, (F) 260 nm, and (G) 220 nm. Each error bar represents the standard deviation of three independent measurements. Data presented as mean±SD (*p<0.05; **p<0.01; ns p>0.05; ****p<0.0001 for KE12, vs. PGC and control NZP; unpaired t-test, n=3).

FIGS. 7A-7G shown an illustration and characterization of PES membrane modification. (A) Schematic of PES membrane modification steps. PES-DM is the intermediate PES membrane that is used for attaching zwitterionic peptides onto the membrane. The zoom-in picture indicated the state of the membrane which was taken directly from each membrane. SEM image for (B) unmodified PES membrane with an average pore size of 431±30.9 nm, (C) intermediate PES membrane (PES-DM) with an average pore size of 415±20.8 nm, and (D) zwitterionic peptides-modified PES membrane (PES-DM-KE12) with an average pore size of 457±21.1 The scale bar is 10 μm. Data presented as mean±SD, n=100 for each membrane. The peptide grafting density was indicated by the number of peptide chains per unit nm² by altering the incubation condition of (E) incubation time, (F) DM concentration, and (G) KE12 concentration. Each error bar represents the standard deviation of three independent measurements (n=3).

FIGS. 8A-8F show the antifouling performance of modified PES membranes. (A) antifouling performance of unmodified PES membrane, intermediate PES membrane (PES-DM), non-zwitterionic control membrane (PES-DM-NZP), Zwitterionic peptides-modified membrane (PES-DM-KE8 and PES-DM-KE12) using IgG protein (1 mg/mL) solution and measure the adsorption of IgG proteins per unit centimeter square by UV-Vis, (B) same membranes using day 0 cell culture media and measured the adsorption at 280 nm, (C) same membranes using 7 days cell culture media and measured adsorption at 280 nm. Lysed cell culture media adsorption at (D) 280 nm, (E) 260 nm, and (F) 220 nm using the same membranes. Each error bar represents the standard deviation of three independent measurements. Data presented as mean±SD (*p<0.05; **p<0.01; ns p>0.05; ****p<0.0001 for KE12, vs. unmodified PES and non-zwitterionic control membrane PES-DM-NZP; unpaired t-test, n=3).

FIGS. 9A-9K show the cytotoxicity of KE12 peptides in the cell culture environment. Live/Dead cells viability confocal microscopy of KE12 peptides in Hek 293 cells followed by 12 hours of exposure to (A) 0.4 μM, (B) 4 μM, and (C) 40 μM KE12 peptide solution. Live/Dead cells viability confocal microscopy of KE12 peptides in Hek 293 cells followed with 24 hours exposure to (D) 0.4 μM, (E) 4 μM, and (F) 40 μM KE12 peptide solution. (G) positive control of Hek 293 cells grown in media without adding zwitterionic peptides solution. (H) negative control of Hek 293 cells with 70% of ethanol treatment. Images were acquired on a Zeiss LSM 780 confocal microscope under low magnification (×40 objective lens). Live cells are shown in FIGS. 9A-9G and dead/dying cells are shown in FIG. 9H. Scale bars represent 50 μm. (I) Viable cell density, (J) viability, and (K) titer production of CHO cells cultivated in batch culture subjecting to 0.4 μM, 4 μM, and 40 μM of KE12 solution. For all conditions, the initial seeding day was assigned Day 0. Culture samples were collected every 24 hr. Bars, mean Bars, mean±s.e.m.; n=3, *p<0.05; NS non-significant. Statistics by two-tailed t-test against the control.

### DEFINITIONS

In order for the present disclosure to be more readily understood, certain terms are first defined below. Additional definitions for the following terms and other terms may be set forth through the specification. If a definition of a term set forth below is inconsistent with a definition in an application or patent that is incorporated by reference, the definition set forth in this application should be used to understand the meaning of the term.

As used in this specification and the appended claims, the singular forms “a,” “an,” and “the” include plural references unless the context clearly dictates otherwise. Thus, for example, a reference to “a method” includes one or more methods, and/or steps of the type described herein and/or which will become apparent to those persons skilled in the art upon reading this disclosure and so forth.

It is also to be understood that the terminology used herein is for the purpose of describing particular embodiments only, and is not intended to be limiting. Further, unless defined otherwise, all technical and scientific terms used herein have the same meaning as commonly understood by one of ordinary skill in the art to which this disclosure pertains. In describing and claiming the methods, systems, computer readable media, and component parts, the following terminology, and grammatical variants thereof, will be used in accordance with the definitions set forth below.

About: As used herein, “about” or “approximately” or “substantially” as applied to one or more values or elements of interest, refers to a value or element that is similar to a stated reference value or element. In certain embodiments, the term “about” or “approximately” or “substantially” refers to a range of values or elements that falls within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value or element unless otherwise stated or otherwise evident from the context (except where such number would exceed 100% of a possible value or element).

Antibody: As used herein, the term “antibody” refers to an immunoglobulin or an antigen-binding domain thereof. The term includes but is not limited to polyclonal, monoclonal, monospecific, polyspecific, non-specific, humanized, human, canonized, canine, felinized, feline, single-chain, chimeric, synthetic, recombinant, hybrid, mutated, grafted, and in vitro generated antibodies. The antibody can include a constant region, or a portion thereof, such as the kappa, lambda, alpha, gamma, delta, epsilon and mu constant region genes. For example, heavy chain constant regions of the various isotypes can be used, including: IgG₁, IgG₂, IgG₃, IgG₄, IgM, IgA₁, IgA₂, IgD, and IgE. By way of example, the light chain constant region can be kappa or lambda. The term “monoclonal antibody” refers to an antibody that displays a single binding specificity and affinity for a particular target, e.g., epitope.

Antifouling: As used herein, “antifouling” in the context of membrane-associated separation or purification processes refers to a property of or related to a given separation or purification process that at least reduces fouling when compared at least to that separation or purification process performed in the absence of that property.

Biomolecule: As used herein, “biomolecule” refers to an organic molecule produced by a living organism. Exemplary biomolecules, include without limitation macromolecules, such as nucleic acids, proteins, peptides, oligomers, carbohydrates, and lipids.

Composition: As used herein, “composition” refers to a combination of two or more different components (e.g., chemical compounds or reagents).

Conjugate: As used herein, the term “conjugate” in the context of chemical structures refers to two or more chemical compounds or moieties that are covalently linked to one another. Chemical moieties can be directly conjugated with one another or indirectly conjugated with one another via a linker or other spacer moiety.

Fouling: As used herein, “fouling” in the context of membrane-associated separation or purification processes refers to a state or condition in which contaminants or other non-target materials are deposited or adsorbed on the surface of a filtration membrane or otherwise inhibit a given separation or purification process, such as by restricting the flow of liquids through a membrane's pores in a porous filtration membrane-associated separation or purification process.

In some embodiments: As used herein, the term “in some embodiments” refers to embodiments of all aspects of the disclosure, unless the context clearly indicates otherwise.

Membrane substrate: As used herein, “membrane substrate” in the context of separation or purification processes refers to a material that can be used to separate target molecules (e.g., target permeate molecules) from other components of a given input composition or solution. Filtration membranes can be porous or non-porous, and typically comprise a solid material which can be coated or derivatized with, or otherwise attached to, a molecule or moiety. An antifouling filtration membrane of the present disclosure includes at least one membrane substrate and at least one antifouling coating.

Moiety: As used herein, “moiety” in the context of chemical compounds or structures refers to one of the portions into which the compound or structure is or can be divided (e.g., a functional group, a substituent group, or the like).

Non-natural: As used herein, “non-natural” in the context of molecules or moieties refers a molecule or moiety that does not occur naturally, such as a non-natural amino acid, a non-natural nucleotide, or the like. A biopolymer, such as a nucleic acid, protein, or peptide, may be non-natural due to its individual sequence (which does not occur naturally) and/or due to other modifications, e.g., structural modifications of nucleotides or amino acids which do not occur naturally.

Nucleic Acid: As used herein, “nucleic acid” refers to a naturally occurring or synthetic oligonucleotide or polynucleotide, whether DNA or RNA or DNA-RNA hybrid, single-stranded or double-stranded, sense or antisense, which is capable of hybridization to a complementary nucleic acid by Watson-Crick base-pairing. Nucleic acids can also include nucleotide analogs (e.g., bromodeoxyuridine (BrdU)), and non-phosphodiester internucleoside linkages (e.g., peptide nucleic acid (PNA) or thiodiester linkages). In particular, nucleic acids can include, without limitation, DNA, RNA, cDNA, gDNA, ssDNA, dsDNA, cfDNA, ctDNA, or any combination thereof.

Protein: As used herein, “protein” or “peptide” refers to a polymer of at least two amino acids attached to one another by one or more peptide bonds. Examples of proteins can include enzymes, hormones, antibodies, and fragments thereof. Peptides may or may not be fragments of full-length proteins. In some embodiments, a protein has more than 50 amino acids attached to one another by peptide bonds. In some embodiments, a peptide has a sequence of 2-50 amino acids attached one to another by one or more peptide bonds.

Sample: As used herein, “sample” refers to a tissue or organ from a subject; a cell (either within a subject, taken directly from a subject, or a cell maintained in culture or from a cultured cell line); a cell lysate (or lysate fraction) or cell extract; or a solution or composition containing one or more molecules derived from a cell or cellular material (e.g., a nucleic acid, a protein or peptide, etc.). A sample may also be any body fluid or excretion (for example, but not limited to, blood, urine, stool, saliva, tears, bile) that contains cells, cell components, or non-cellular fractions.

System: As used herein, “system” in the context of analytical instrumentation refers a group of objects and/or devices that form a network for performing a desired objective.

Target: As used herein, “target” refers to a molecule (e.g., a nucleic acid, a protein or peptide, etc.), or portion thereof, that is to be purified, isolated, detected, and/or otherwise analyzed.

Zwitterionic: As used herein, “zwitterionic” in the context of molecules or moieties refers to a molecule or moiety having a net formal charge of zero, but with negative and positive formal charges on individual atoms within its structure.

### DETAILED DESCRIPTION

### Introduction

Biofouling is the accumulation of undesired biological organic materials on membrane substrates, which causes severe risk in medical, marine, and industrial fields. To address this problem, in certain aspects, the present disclosure provides antifouling membranes, methods, devices, kits, and systems that are of use in minimizing membrane fouling when performing various applications, including protein or other target molecule purification processes or in other foulant environments. The antifouling membranes (e.g., gold coated substrates and polyethersulfone (PES) membranes, among many other suitable membrane substrates) disclosed herein are coated with or otherwise comprise zwitterionic materials having antifouling properties. In some embodiments, for example, the zwitterionic materials consist of alternating charged groups, such as zwitterionic peptides composed of alternating lysine (K) and glutamic acid (E) amino acid residues of varying lengths that employ differing linkage chemistries. In some embodiments, zwitterionic peptides with more charged groups and more hydrophilic linkers exhibit better antifouling performance in protein, cell culture environment, and even lysed cell conditions. Some exemplary embodiments involve the use of zwitterionic peptides composed of non-natural amino acids to create antifouling membranes. As also described herein, increased peptide grafting density can also improve the antifouling performance of zwitterionic peptide modified substrates. These and other aspects will be apparent upon a complete review of the present disclosure, including the accompanying figures.

### Exemplary Antifouling Membranes

In some aspects, the present disclosure provides antifouling filtration membranes of use in numerous medical and industrial applications, among other areas of use. Biofouling of polymeric membranes in continuous protein separation processes is an on-going challenge in the purification industry because it reduces purification efficiency and membrane lifetime while increasing production costs. Accordingly, the present disclosure provides mechanically stable membranes that minimize biofouling and are capable of operating under conditions typically utilized in, for example, tangential flow filtration (TFF) and alternating tangential flow filtration (ATF) systems.

In overview, an antifouling filtration membrane as described herein typically includes a membrane substrate and an antifouling coating disposed on one or more surfaces of the membrane substrate. The antifouling coating includes a plurality of zwitterionic molecules or moieties at a density sufficient to form a hydration shell when an aqueous input composition (e.g., a protein solution, a cell culture medium, a lysed cell solution, and/or the like) contacts the antifouling coating. In some embodiments, the antifouling filtration membranes of the present disclosure are substantially non-cytotoxic. The hydration shell acts to substantially prevent fouling components in the aqueous input composition from adsorbing on the membrane substrate while substantially permitting target permeate molecules (e.g., expressed therapeutic proteins or peptides, etc.) in the aqueous input composition to flow through the membrane substrate. In some embodiments, for example, an antifouling filtration membrane as described herein adsorbs less than about 1.5 μg (e.g., about 1.4 μg, about 1.3 μg, about 1.2 μg, about 1.1 μg, about 1.0 μg, about 0.9 μg, about 0.8 μg, about 0.7 μg, about 0.6 μg, about 0.5 μg, about 0.4 μg, about 0.3 μg, about 0.2 μg, about 0.1 μg, or even less) of an IgG protein/cm² of the membrane substrate when the membrane substrate is exposed to the IgG protein.

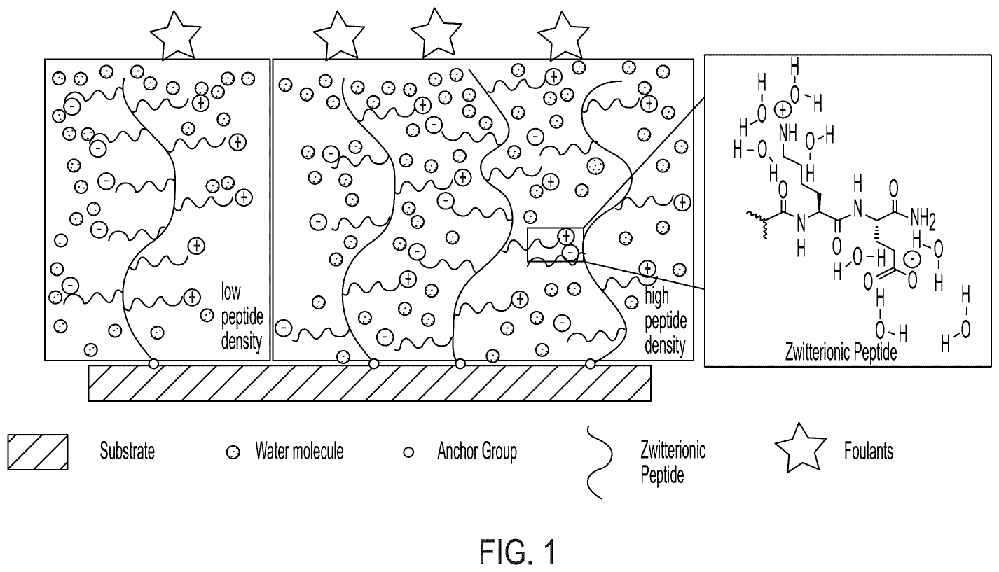

To illustrate, FIG. 1 is a schematic diagram of an exemplary zwitterionic peptide antifouling mechanism according to some embodiments. As shown, the membrane substrate is depicted as comprising a gold coated surface to which zwitterionic peptides are conjugated via anchor groups. The charged groups on the zwitterionic peptides attract water molecules in the input composition and for a hydration shell. The hydration shell substantially prevents foulants in the input composition from contacting the gold coated surface of the membrane substrate. A denser hydration shell can be achieved with increased charge density.

Various membrane substrate materials are optionally used in the antifouling filtration membranes of the present disclosure. In some embodiments, membrane substrates are porous, whereas in other embodiments they are non-porous. Some exemplary membrane substrates that can be adapted for use in the antifouling filtration membranes of the present disclosure, include polyacrynitrile (PAN), poly(vinylidene fluoride) (PVDF), polysulfone (PSF), poly(ethersulfone) (PES), poly(glycidyl methacrylate) (PGMA), cellulose, cross-linked regenerated cellulose (xRC), cellulose acetate (CA), and combinations thereof.

The antifouling filtration membranes of the present disclosure can also utilize various types of zwitterionic molecules or moieties. In some embodiments, for example, the zwitterionic molecules or moieties are molecules, such as polyethylene glycol (PEG), dextran, polyethylenimine (PEI), sulfobetaine methacrylate (SBMA), poly(methyl methacrylate (PMMA), sulfobetaine-2-vinyl pyridine (SB2VP), (3-(methacryloylamino)propyl)dimethyl (3-sulfopropyl)ammonium hydroxide (MPDSAH), hexafluorobutyl methacrylate (HFBM), N,N-dimethyl-N-methacryloxyethyl N-(3-sulfopropyl) ammonium betaine (DMMSA), 3-[[2-(methacryloyloxy)ethyl]dimethylammonio]propionate (CBMA), poly(2-methacryloyloxyethyl phosphorylcholine methacrylate) (PMPC), and combinations thereof.

In some embodiments, the zwitterionic molecules or moieties comprise biomolecules, such as unmodified and/or modified amino acids, unmodified and/or modified nucleosides, unmodified and/or modified carbohydrates, and/or unmodified and/or modified lipids. In some embodiments, the zwitterionic molecules or moieties comprise at least one zwitterionic pair of amino acid residues (e.g., about 2, about 3, about 4, about 5, about 6, about 7, about 8, about 9, about 10, or more zwitterionic pairs of amino acid residues). In some embodiments, the zwitterionic molecules or moieties comprise zwitterionic polyampholyte peptides. In some embodiments, the zwitterionic molecules or moieties comprise non-natural amino acid residues.

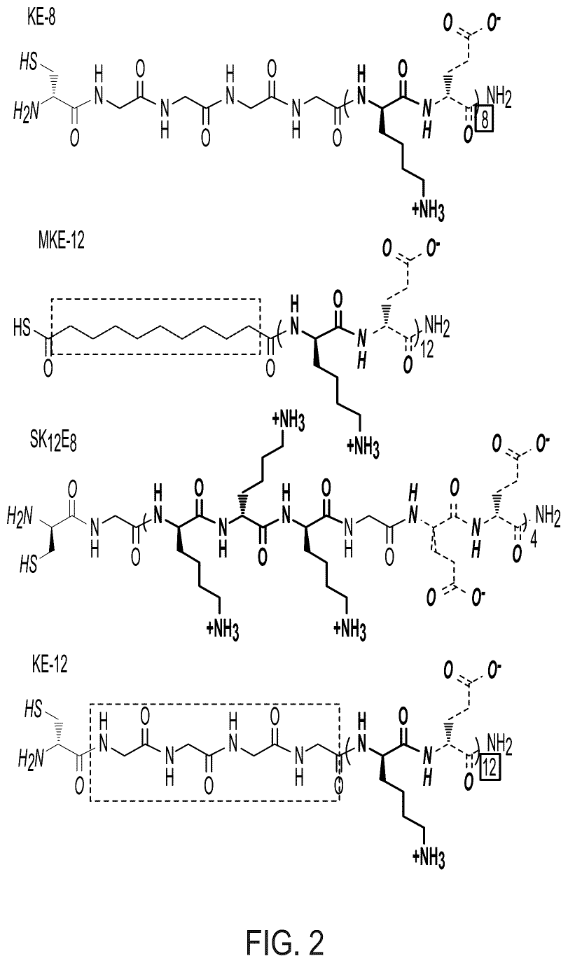

To further illustrate exemplary zwitterionic molecules or moieties that can be used in the antifouling filtration membranes of the present disclosure, FIG. 2 shows exemplary zwitterionic peptide designs of varying length and linker type according to some embodiments. As shown, FIG. 2 depicts structures KE-8, MKE-12, SK₁₂E₈, and KE-12, which have varying lengths, numbers of charged groups, linkers, hydrophilicities, and zwitterionic characteristics.

As referenced herein, a denser hydration shell can be achieved with increased charge density. In some embodiments, for example, the antifouling filtration membranes of the present disclosure include zwitterionic peptides having a grafting density on the surface of the membrane substrate of at least about 0.05 chains/nm² (e.g., about 0.06 chains/nm², about 0.07 chains/nm², about 0.08 chains/nm², about 0.09 chains/nm², about 0.1 chains/nm², or more).

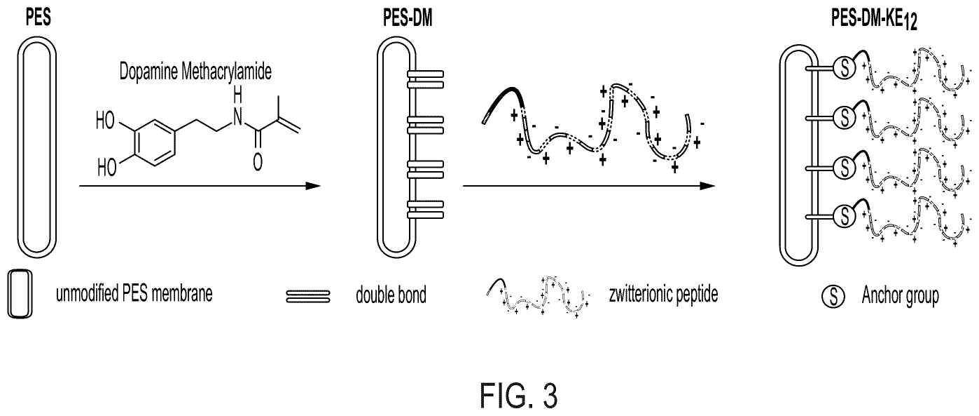

In some embodiments, zwitterionic molecules or moieties are covalently conjugated to the surfaces of membrane substrates, whereas in other embodiments, they are non-covalently conjugated to the surfaces of membrane substrates. In some embodiments, zwitterionic molecules or moieties conjugated to the surface of the membrane substrate via one or more linker or anchor moieties. In some embodiments, for example, zwitterionic molecules or moieties conjugated to the surfaces of membrane substrates via dopamine methacrylamide (DM) using thiol-ene chemistry. To illustrate, FIG. 3 shows an exemplary chemical modification of a poly(ethersulfone) (PES) membrane in which KE-12 structures are conjugated to the PES membrane via DM.

### Exemplary Systems and Computer Readable Media

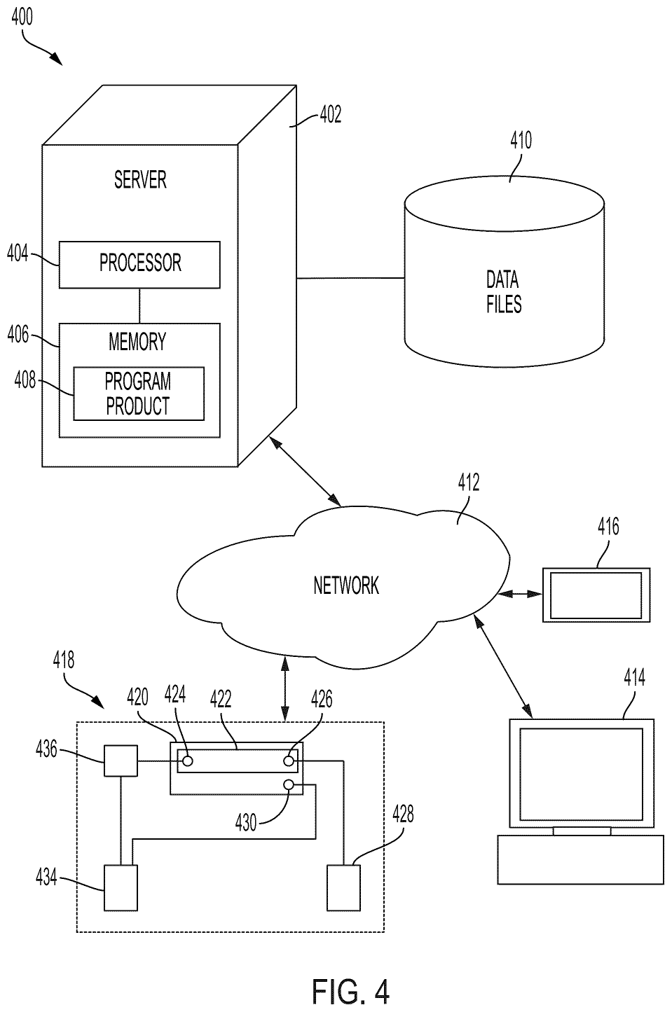

The present disclosure also provides various systems and computer program products or machine readable media. In some aspects, for example, the methods described herein are optionally performed or facilitated at least in part using systems, distributed computing hardware and applications (e.g., cloud computing services), electronic communication networks, communication interfaces, computer program products, machine readable media, electronic storage media, software (e.g., machine-executable code or logic instructions) and/or the like. To illustrate, FIG. 4 provides a schematic diagram of an exemplary system suitable for use with implementing at least aspects of the methods disclosed in this application. As shown, system 400 includes at least one controller or computer, e.g., server 402 (e.g., a search engine server), which includes processor 404 and memory, storage device, or memory component 406, and one or more other communication devices 414, 416, (e.g., client-side computer terminals, telephones, tablets, laptops, other mobile devices, etc. (e.g., for receiving purification run status information, etc.)) positioned remote from filtration subassembly (e.g., a tangential flow filtration (TFF) subassembly, an alternating tangential flow filtration (ATF) subassembly, or the like) 418, and in communication with the remote server 402, through electronic communication network 412, such as the Internet or other internetwork. Communication devices 414, 416 typically include an electronic display (e.g., an internet enabled computer or the like) in communication with, e.g., server 402 computer over network 412 in which the electronic display comprises a user interface (e.g., a graphical user interface (GUI), a web-based user interface, and/or the like) for displaying results upon implementing the methods described herein. In certain aspects, communication networks also encompass the physical transfer of data from one location to another, for example, using a hard drive, thumb drive, or other data storage mechanism. System 400 also includes program product 408 stored on a computer or machine readable medium, such as, for example, one or more of various types of memory, such as memory 406 of server 402, that is readable by the server 402, to facilitate, for example, a guided search application or other executable by one or more other communication devices, such as 414 (schematically shown as a desktop or personal computer). In some aspects, system 400 optionally also includes at least one database server, such as, for example, server 410 associated with an online website having data stored thereon (e.g., entries corresponding to input compositions, purification batches, etc.) searchable either directly or through search engine server 402. System 400 optionally also includes one or more other servers positioned remotely from server 402, each of which are optionally associated with one or more database servers 410 located remotely or located local to each of the other servers. The other servers can beneficially provide service to geographically remote users and enhance geographically distributed operations.

As understood by those of ordinary skill in the art, memory 406 of the server 402 optionally includes volatile and/or nonvolatile memory including, for example, RAM, ROM, and magnetic or optical disks, among others. It is also understood by those of ordinary skill in the art that although illustrated as a single server, the illustrated configuration of server 402 is given only by way of example and that other types of servers or computers configured according to various other methodologies or architectures can also be used. Server 402 shown schematically in FIG. 4, represents a server or server cluster or server farm and is not limited to any individual physical server. The server site may be deployed as a server farm or server cluster managed by a server hosting provider. The number of servers and their architecture and configuration may be increased based on usage, demand and capacity requirements for the system 400. As also understood by those of ordinary skill in the art, other user communication devices 414, 416 in these aspects, for example, can be a laptop, desktop, tablet, personal digital assistant (PDA), cell phone, server, or other types of computers. As known and understood by those of ordinary skill in the art, network 412 can include an internet, intranet, a telecommunication network, an extranet, or world wide web of a plurality of computers/servers in communication with one or more other computers through a communication network, and/or portions of a local or other area network.

As further understood by those of ordinary skill in the art, exemplary program product or machine readable medium 408 is optionally in the form of microcode, programs, cloud computing format, routines, and/or symbolic languages that provide one or more sets of ordered operations that control the functioning of the hardware and direct its operation. Program product 408, according to an exemplary aspect, also need not reside in its entirety in volatile memory, but can be selectively loaded, as necessary, according to various methodologies as known and understood by those of ordinary skill in the art.

As further understood by those of ordinary skill in the art, the term “computer-readable medium” or “machine-readable medium” refers to any medium that participates in providing instructions to a processor for execution. To illustrate, the term “computer-readable medium” or “machine-readable medium” encompasses distribution media, cloud computing formats, intermediate storage media, execution memory of a computer, and any other medium or device capable of storing program product 408 implementing the functionality or processes of various aspects of the present disclosure, for example, for reading by a computer. A “computer-readable medium” or “machine-readable medium” may take many forms, including but not limited to, non-volatile media, volatile media, and transmission media. Non-volatile media includes, for example, optical or magnetic disks. Volatile media includes dynamic memory, such as the main memory of a given system. Transmission media includes coaxial cables, copper wire and fiber optics, including the wires that comprise a bus. Transmission media can also take the form of acoustic or light waves, such as those generated during radio wave and infrared data communications, among others. Exemplary forms of computer-readable media include a floppy disk, a flexible disk, hard disk, magnetic tape, a flash drive, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave, or any other medium from which a computer can read.

Program product 408 is optionally copied from the computer-readable medium to a hard disk or a similar intermediate storage medium. When program product 408, or portions thereof, are to be run, it is optionally loaded from their distribution medium, their intermediate storage medium, or the like into the execution memory of one or more computers, configuring the computer(s) to act in accordance with the functionality or method of various aspects. All such operations are well known to those of ordinary skill in the art of, for example, computer systems.

To further illustrate, in certain aspects, this application provides systems that include one or more processors, and one or more memory components in communication with the processor. The memory component typically includes one or more instructions that, when executed, cause the processor to provide information that causes input composition information, purification run status, purification data, and/or the like to be displayed (e.g., via communication devices 414, 416 or the like) and/or receive information from other system components and/or from a system user (e.g., via communication devices 414, 416, or the like).

In some aspects, program product 408 includes non-transitory computer-executable instructions which, when executed by electronic processor 404 perform at least: conveying an aqueous input composition into a filtration module through an inlet port from a storage container when the storage container contains the aqueous input composition.

System 400 also includes filtration subassembly 418 that is configured to perform various aspects of the methods described herein. As shown, filtration subassembly 418 includes filtration module 420, which includes inlet port 424 in fluid communication with input composition storage container 434 via operably connected fluid conveyance mechanism 436 (e.g., a pump or the like). Filtration module 420 also includes membrane component 422, which comprises an antifouling filtration membrane as described herein. In some embodiments, the antifouling filtration membrane comprises a hollow fiber, spiral-wound, and/or flat plate configuration. In addition, filtration module 420 also includes filtrate outlet port in fluid communication with filtrate storage container 428 and retentate outlet port 430 in fluid communication with input composition storage container 434 via retentate fluid circuit 432.

### Exemplary Methods

The present disclosure also provides various methods related to the antifouling filtration membranes disclosed herein. In some embodiments, for example, the present disclosure relates to methods of separating target permeate molecules (e.g., target permeate biomolecules, such as proteins, peptides, or nucleic acids) from retentate molecules in an aqueous input composition. The methods include contacting the aqueous input composition with an antifouling filtration membrane as described herein (e.g., as part of a tangential flow filtration (TFF) system, an alternating tangential flow filtration (ATF) system, or the like) such that a resultant hydration shell substantially prevents fouling components in the aqueous input composition from adsorbing on the membrane substrate while substantially permitting the target permeate molecules in the aqueous input composition to flow through the membrane substrate. The antifouling filtration membrane also substantially prevents the retentate molecules in the aqueous input composition from flowing through the membrane substrate to thereby effect the separation of the target permeate molecules from the retentate molecules in the aqueous input composition. The present disclosure also includes methods of producing antifouling filtration membranes. In some embodiments, these methods include coating a surface of a membrane substrate with an antifouling coating as described herein.

### EXAMPLE: Improving the Antifouling Performance of Polyethersulfone TFF Membranes With Zwitterionic Peptides of Non-Proteinogenic Amino Acids Under Biological Environment

### Introduction

Biofouling on substrates by proteins, cellular debris, and other biologics has become an increasingly important concern that limits the development of biomedical, water treatment, protein separation, and a wide range of other areas. The interaction between the substrate surface and the foulants, which can be inorganic, organic, or biological molecules in many various forms, results in fouling. Numerous strategies have been used for treating the fouling issue in different fields and have overcome related challenges in certain applications. Antifouling and antimicrobial biomaterials using Poly(ethylene glycol) (PEG) based, enzyme based, superhydrophobic, and polyzwitterionic are used for limiting the microbial adhesion and biofilm formation on medical devices surfaces. In wastewater treatment, one commonly used strategy is to apply antifouling reverse osmosis membranes in pretreatment processes. To lessen the fouling impact, several attempts have been made, including surface modification, monomer selection, and improved polymerization processes.

As for protein separation and purification processes, they often combine the strategies from biomedical devices and wastewater treatment by using novel materials to coat substrates to achieve antifouling efficacy. PEG and oligo(ethylene glycol) (OEG) are common coating materials used to inhibit foulant adsorption on substrates. Hydrogen-bonding induced surface hydration is considered as the key factor of antifouling properties in PEG and OEG. However, the oxidative nature of PEG and OEG is susceptible to degradation over time and is not as effective as zwitterionic polymeric materials, especially in high ionic salt buffers. Zwitterionic polymers are promising antifouling alternatives which maintain the mechanically stable properties of a substrate while possessing the antifouling characteristic of a hydrophilic polymer. Zwitterionic polymers can induce surface hydration due to the ionic solvation and form a denser hydration shell on the surface to prevent foulant adsorption by creating a high energy barrier. Zwitterionic polymers consisting of the same number of negative and positive charged groups are classified into two major types: polybetaines and polypeptides. The equal number of cationic and anionic groups on a polymer chain enables zwitterionic polymers to attract water molecule and to possess strong hydrophilicity. Polybetaines have both cationic moieties (quaternary ammonium groups) and anionic moieties (sulfonate, carboxylate, and phosphate groups) in the same molecular chain. Others have demonstrated the antifouling abilities of synthesizing polypropylene (PP) fibrous membranes grafted with poly(sulfobetaine methacylate). As for zwitterionic peptides, they can include an equal number of positively and negatively charged amino acid residues. Some groups have demonstrated the antifouling properties of zwitterionic peptides coated on self-assembled monolayers (SAMs). However, the investigation of the antifouling properties of zwitterionic materials in cell culture environment and even extreme conditions has yet to be studied.

In this example, we chose zwitterionic peptides over polybetaine due to the design versatility and biocompatibility of peptides. By attaching the zwitterionic peptides onto gold substrate, we proved the antifouling properties of zwitterionic peptides using different testing solution including protein solution, cell culture media, and lysed cell solution. We also provide a new membrane modification chemistry of functionalizing the zwitterionic peptides onto the PES membrane and verify the antifouling properties of the modified membranes in different conditions. These rationally designed peptides exhibited the resistance of foulants even under extreme lysed cell conditions, which indicated the excellent antifouling performance of zwitterionic peptides.

### Results And Discussion

### Overall Process Illustration and Molecule Design

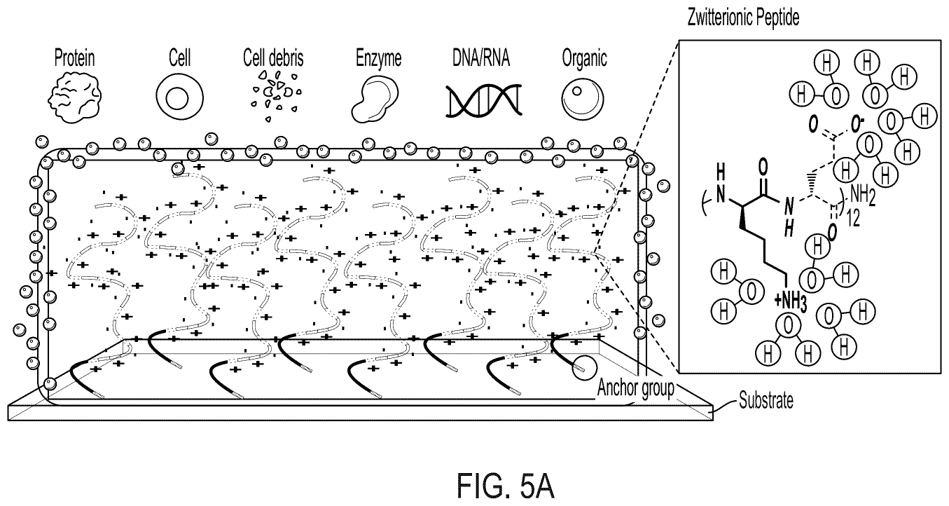

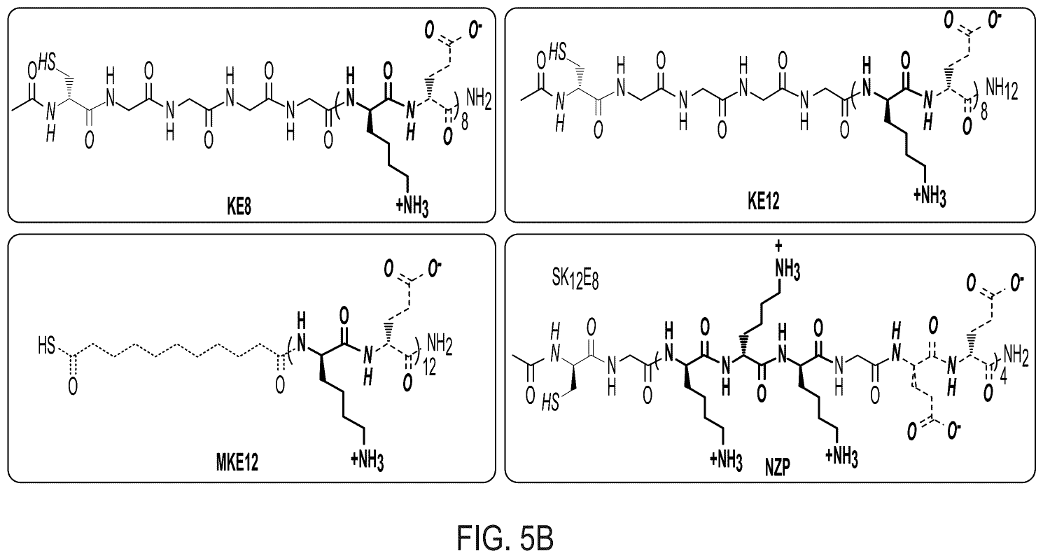

The zwitterionic peptide modified substrate antifouling mechanism is illustrated in FIG. 5A. The chains on the substrate represent the zwitterionic peptides, which consists of alternating positively charged (segments labeled with “+”) and negatively charged (segments labeled with “−”) amino acid residues. Zwitterionic peptides are attached on the substrate via the anchor group and linker. Water molecules could be attracted by charged groups and form a hydration shell (blue molecule), which can prevent different types of foulants (proteins, cells, cell debris, enzymes, DNA/RNA, and organic molecules) from being adsorbed by the substrate.

In designing the zwitterionic peptides, we aimed to include alternating positively and negatively charged natural amino acid residues to have a zwitterionic characteristic. FIG. 5B showed the molecular design of four different peptides. We altered the number of charged groups and the design of the linker to demonstrate the key determinates of the antifouling performance. The first molecule KE8 consists of 8 pairs of lysine (K) residues and glutamic acid (E) residues, in which lysine provides the positive charge and glutamic acid provides the negative charge. Four glycine (G) residues are included the linker to increase the flexibility of the zwitterionic peptides followed by a cystine as the anchor group. Cystine contains a thiol group, which is usually used in the surface modification process to perform click chemistry. The second molecule is KE12, which has a similar design to KE8, but with 12 pairs of charged groups. We changed the linker design for the third molecule. Instead of using four glycine residues as the linker, we used 11-mercaptoundecanoic acid, which is composed of an eleven-hydrocarbon with a thiol group and carboxylic acid at the end. This linear hydrocarbon linker is more hydrophobic than the four glycine residue linker. Thus, with these molecular designs, we could compare the effect on antifouling performance by having a different number of charged groups and different linker designs. All the amino acids were selected with D-amino acids because of their lessened susceptibility to enzymatic processing. The purification was performed by HPLC, and the mass was confirmed by the ESI.

### Zwitterionic Peptide Modified Gold-Coated Silicon Wafers and Non-Specific Protein Adsorption Assay

The gold-coated silicon wafers were obtained from Platypus Technologies (Madison, WI, USA). The gold chips were first immersed in Nanopure water and cleaned by a sonicator. Then the gold chips were cleaned in basic piranha solution (NH₄OH/H₂O₂=7:3) at 75° C. for 20 minutes followed by extensive rinsing with Nanopure water and blow drying the chips with nitrogen gas. The gold chips were stored in a vacuum desiccator to remove any excess water. The gold chips were then cleaned by plasma cleaner (Denton evaporator) for half hour to further clean the organic particle on the surface of the gold chips and transfer electrons attached onto the surface. Ethanol and Nanopure water rinses were repeated three times and the chips were dried with N₂ before use. Both piranha solution and plasma cleaner were used to remove the organic matter and impurities on the surface while increasing the surface hydrophilicity by attaching electrons. The concentration of the zwitterionic peptides was 1 mg/mL in PBS buffer solution and the gold chips were incubated in zwitterionic peptide solution for 24 hours to make zwitterionic peptides modified gold chips.

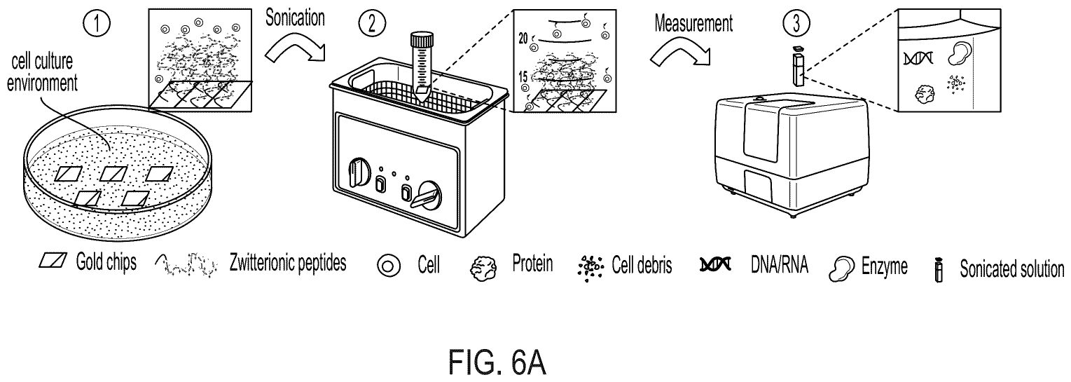

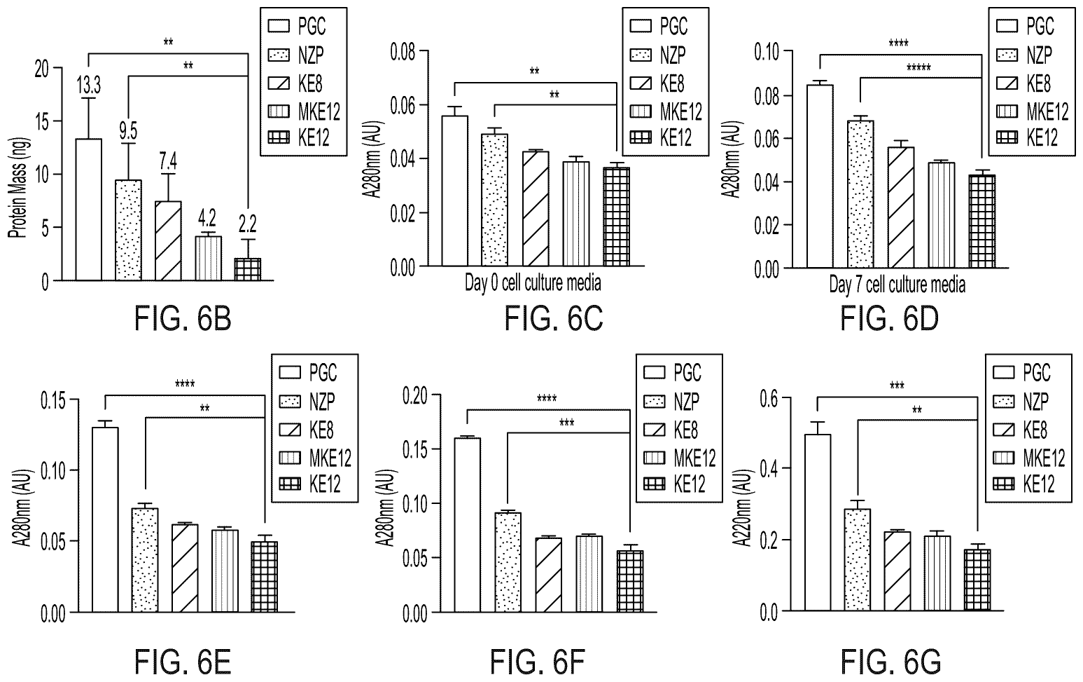

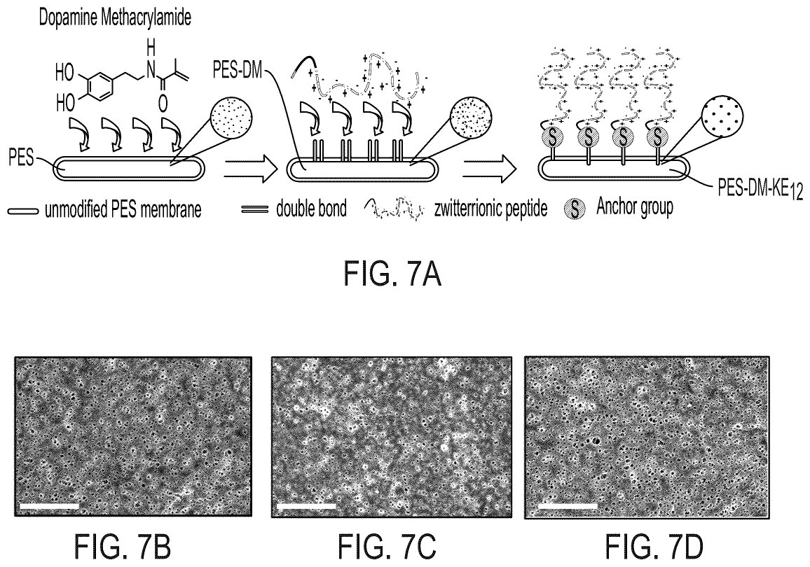

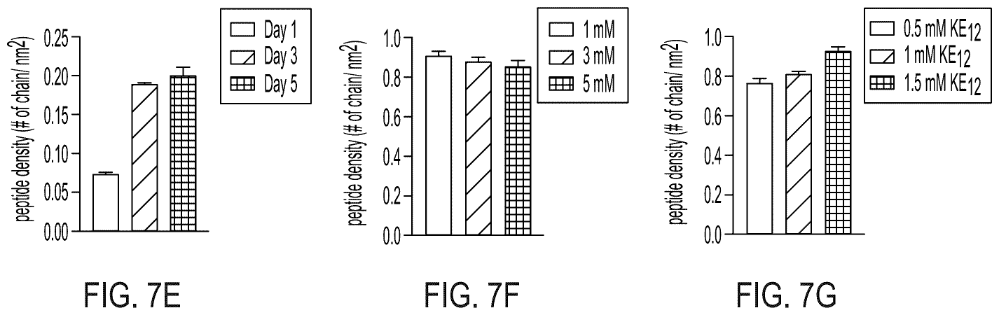

We first investigated non-specific protein adsorption of zwitterionic peptide modified gold chips to prove the concept of the “hydration shell theory.” Zwitterionic peptides (1 mg/mL) were attached on the gold chips via well-established thiol-gold chemistry. To assess the antifouling abilities of the zwitterionic peptide-modified gold chips, we used the sonication technique to determine how much proteins or foulant were adsorbed by the gold chips, which is shown in FIG. 6A. Proteins and other foulants are non-covalently bound on the gold surface, which can be sonicated off the surface. By collecting the sonication solution, we ran UV-Vis to determine the adsorption level of the foulants. FIG. 6B indicated the antifouling abilities of peptide modified gold chips using 1 mg/mL IgG protein solution and compared with plain gold chip (PGC). Beer's law and the known absorptivity value of the IgG protein solution helped to determine the adsorbed protein mass of the gold chips. The more proteins that gold chips adsorbed, the less antifouling performance of the gold chips. From the results, PGC adsorbed more proteins (13.3 ng/cm²) than the peptides-modified gold chips. The control molecule (NZP) without any zwitterionic characteristic adsorbed more proteins (9.5 ng/cm²) than the zwitterionic peptide-modified gold chips. Among all the zwitterionic peptide-modified gold chips, KE12 exhibited the best antifouling performance by adsorbing the least IgG proteins (2.2 ng/cm²). To further investigate the antifouling abilities of zwitterionic peptides for other foulants, we examined the UV adsorption using cell culture media. FIG. 6C and FIG. 6D indicated the adsorption level of PGC and peptides-modified gold chips in Day 0 cell culture media (fresh media) and Day 7 cell culture media respectively. The results are consistent with using IgG protein solution and KE12 exhibited the best antifouling performance in cell culture. We chose the absorbance at 280 nm since most of the proteins are adsorbed at 280 nm. Moreover, we wanted to determine the antifouling abilities of zwitterionic peptide-modified gold chips at extreme conditions, so we used lysed cell solution and measured the absorbance for the gold chips at a different wavelength. We chose three different wavelengths shown in FIGS. 6E, 6F, and 6G, which were A280 nm, A260 nm, and A220 nm, to measure the antifouling abilities of the zwitterionic peptide-modified gold chips. A280 nm is the absorbance of most of the proteins, A260 nm is usually the absorbance of DNA and RNA, and A220 nm is typically for certain amino acids such as tyrosine and tryptophan. We obtained the same results as the previous experiment, namely, that KE12 exhibited the best antifouling performance among all the zwitterionic peptides. As shown in FIG. 7A, it's notable to mention that 2.2 ng/cm² adsorption of the IgG proteins is much lower than the commonly acceptable ultralow fouling criterion of 5 ng/cm². This set of experiments indicated the protein-resisting effects of zwitterionic peptide-modified gold chips, as well as the resistance for the other type of foulant in extreme environments.

### PES Membrane Modification Process and Characterization

The great impact of zwitterionic peptide-modified gold chips in protein resistance attracted our great interest in the zwitterionic peptide-modified membrane because membrane modification has been broadly used in protein purification, water treatment, and medical device fields. We chose a commercially available PES membrane, which has been commonly used in the TFF filtration system for the protein purification process. In FIG. 7A, the deposition of dopamine methacrylamide (DM) onto the PES membrane provides a double bond for zwitterionic peptides to bind. DM is a brownish powder that is soluble in a slightly basic environment. The success of the deposition of DM could be demonstrated by the significant color change (from white to orange). Thiol-ene chemistry has found many diverse applications in the synthetic membrane modification process, which is an organic reaction between a thiol group and an alkene group to form a thioether. This thioether bond is robust enough to attach the zwitterionic peptides onto the membrane. In FIG. 7A, we chose KE12 as an example which contains cysteine as the anchor group and 12 pairs of positively charged and negatively charged amino acids.

We then evaluated the surface morphology of the unmodified PES membrane, dopamine methacrylamide-modified PES membrane (PES-DM), and the zwitterionic peptides-modified PES membrane using SEM as shown in FIGS. 7B, 7C, and 7D. 100 random groups were chosen to measure the pore size of each membrane. The pore size of the KE12-modified PES membrane is 457±21.1 nm, which showed no difference from the unmodified PES membrane and intermediate membrane (PES-DM). This suggested that the designed membrane modification process didn't alter the pore size and affected the functionality of the membrane. The successful attachment of zwitterionic peptides is verified by Fourier transform infrared spectroscopy (FTIR) via detecting the C—S peak. We compared the FTIR spectrum between PES-DM and PES-DM-KE12 and observed the missing peak of the C—H alkene bend at 1000-875 cm⁻¹ and the new peak of the C—S bond at 730-580 cm⁻¹, which corresponds to the successful thiol-ene chemistry.

Furthermore, we evaluated the grafting density of the modified membrane by altering the incubation conditions. The grafting density of the zwitterionic peptides on the PES membrane is crucial to the antifouling performance. The higher the grafting density of the peptides on the membrane, the better the antifouling effect. In this study, we expected to optimize the modification conditions to achieve the highest grafting density of the zwitterionic peptides. In FIG. 7E, we compared different zwitterionic peptides' incubation times from 1 day, 3 days to 5 days. The results indicated there is a significant increase from Day 1 (0.07 chain/nm²) to Day 3 (0.18 chain/nm²) and a minor increase from Day 3 to Day 5 (0.2 chain/nm²). This showed the incubation time of zwitterionic peptides could affect the peptide density. We then test the protein adsorption for day 1, day 3, and day 5 membranes using 1 mg/mL IgG solution. The results are consistent with the peptide density. Lower peptide density gives higher protein adsorption. Day 1 adsorbed 1.3 μg/cm² of IgG proteins, whereas day 3 and day 5 adsorbed a similar amount of IgG (0.9 μg/cm²). A similar level of protein adsorption might contribute to the maximum surface grafting density. Another important factor that affects the grafting density is the concentration of the intermediate dopamine metharcylamide (DM). DM provides a double bond onto the PES membrane, which allows zwitterionic peptides to attach via thiol-ene chemistry. Interestingly, we found out that increasing the concentration of DM did not significantly increase the peptides grafting density. In FIG. 7F, we compared 1 mM, 3 mM, and 5 mM of DM, but obtained a similar peptide grafting density as 0.9 chain/nm². However, we observed an increased level of protein adsorption for these 3 concentrations, especially from 1 mM to 3 mM. Opposite to our instinct, the results showed a higher level of protein adsorption which increased the peptide grafting density. This might contribute to the adhesive nature of dopamine methacrylamide. As the concentration of DM increases over the optimal level, more proteins adhere to the surface of the membrane causing an adverse effect on protein resistance. Based on that, we conducted experiments to find the optimal zwitterionic peptide concentration to achieve the highest grafting density, which is shown in FIG. 7G. Obviously, a higher concentration of zwitterionic peptides results in higher peptide grafting density and a lower level of protein adsorption. Based on these results, we determined the optimal conditions for the peptide grafting process to achieve the best antifouling performance in the use of a zwitterionic peptide-modified membrane.

### Antifouling Performance of Unmodified PES Membrane and Peptide-Modified Membrane in Static Condition

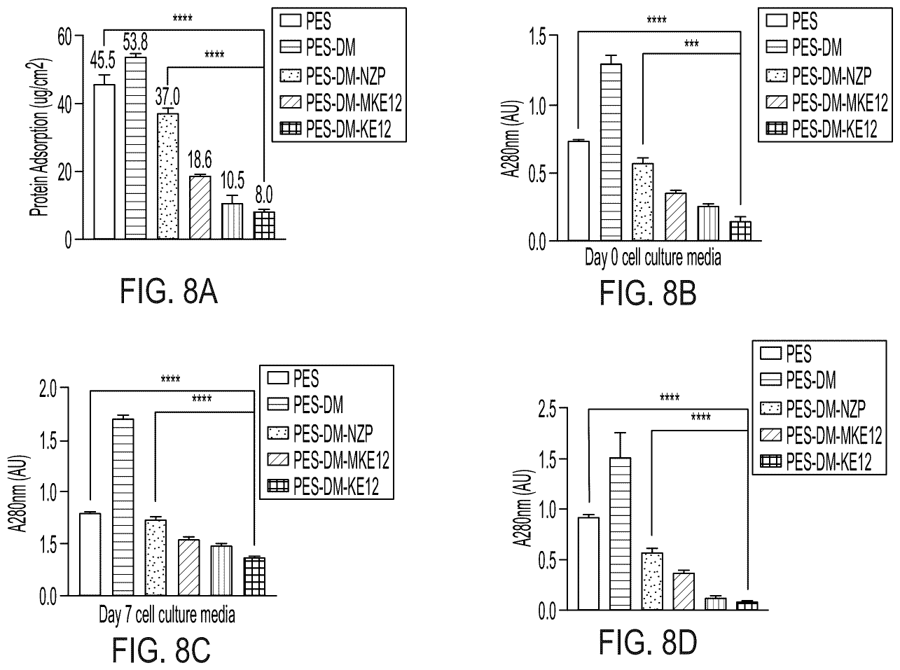

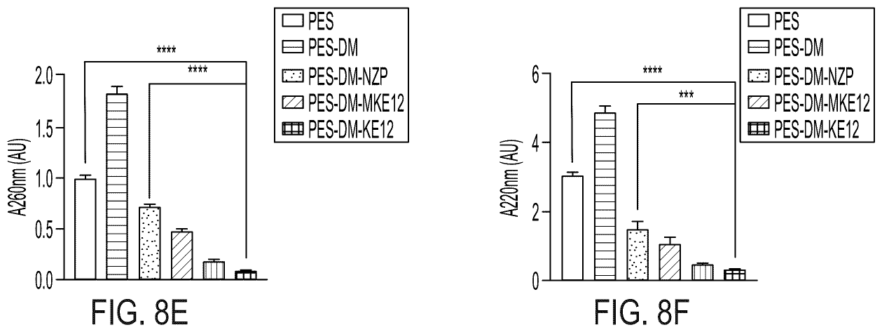

We further assessed the antifouling performance of zwitterionic peptide-modified PES membrane in the different testing solutions and compared it with unmodified PES membrane and intermediate PES-DM membrane. The same sonication technique was applied to this protein-resisting assay and less protein adsorption indicated the best antifouling effect. We observed the same trend in membrane protein adsorption assay as in gold chips protein adsorption assay. In FIG. 8A, unmodified PES membrane adsorbed 45.5 μg IgG proteins per cm², which is almost 6-fold higher than the adsorption of KE12 peptide-modified membranes (8.0 μg/cm²). Other zwitterionic peptide-modified membranes such as PES-DM-KE8 and PES-DM-MKE also exhibited great antifouling performance, but not as good as PES-DM-KE12. Interestingly, the intermediate PES membrane (PES-DM) showed higher protein adsorption than the unmodified PES membrane. One possible reason contributing to this phenomenon is the adhesive nature of dopamine. The proteins might be stuck onto dopamine methacrylamide-modified membrane, which causes the increased level of protein adsorption. However, this is indirect evidence to prove the antifouling abilities of the zwitterionic peptides-modified membrane. As we attached the zwitterionic peptides onto the PES-DM, the antifouling ability was significantly improved and adsorbed less protein even than the unmodified membranes. This result is consistent with using other testing solutions. FIGS. 8B and 8C indicated zwitterionic peptides-modified membranes are effective in protein resistance in the more complex cell culture environment. We determined the absorbance of the sonication solution at 280 nm in both fresh media and 7 days cell culture media. Day 7 cell culture media contains more proteins than Day 0 cell culture media, which explained the higher absorbance for all the membranes in FIG. 8C than in FIG. 8B. As for FIGS. 8D, 8E, and 8F, they represented the adsorption for the membranes at 280 nm, 260 nm, and 220 nm respectively and the results are consistent with using IgG protein solution and cell culture media. Zwitterionic peptide-modified membranes exhibited the significant potential of being antifouling materials in the use of protein purification field. The great antifouling abilities of all the foulants from cell culture media and even lysed cell environment provide a new direction of membrane modification for antifouling materials.

### Cytotoxicity of the Zwitterionic Peptides in Cell Culture Environment and Impact on Protein Production

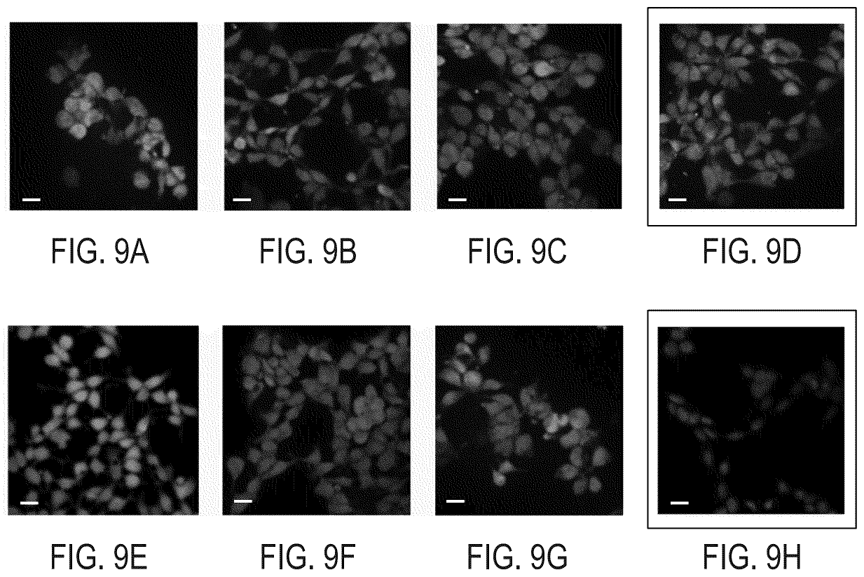

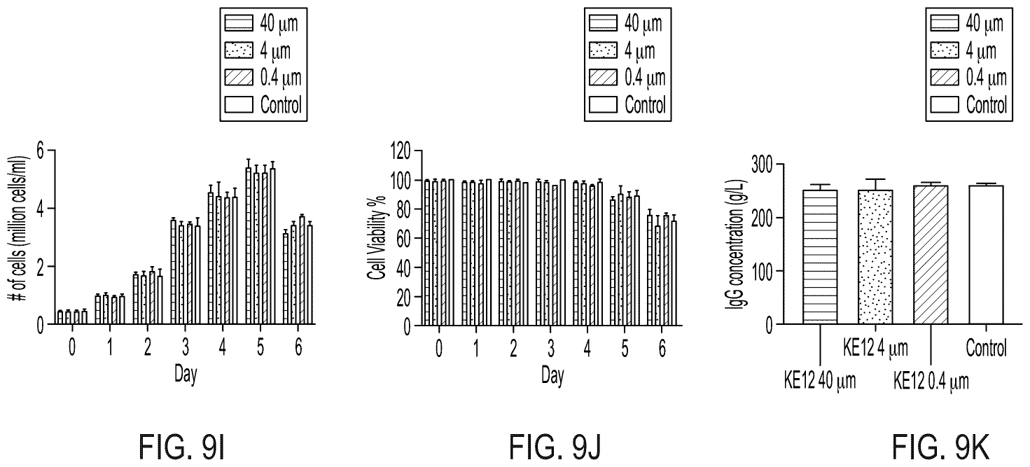

We directly visualized the cytotoxicity of the KE12 peptide in Hek 293 cell line via confocal fluorescence microscopy, which is shown in FIG. 9A. Hek 293 cell line is isolated from the human kidney and has been broadly used for cell viability assays. We used calcein AM and ethidium homodimer-1 as fluorescence staining solutions. Live cells showed green fluorescence (FIGS. 9A-9G) and dead cells showed red fluorescence (FIG. 9H). We measured two different time points (12 hr and 24 hr) in three different concentrations (0.4 μM, 4 μM, and 40 μM) of KE12 peptides. The live control group was in pure media without adding any peptide solution and the dead control group is treated with 70% of ethanol. No dead cells were observed in zwitterionic peptides treated groups for both 12 hr timepoint and 24 hr timepoint. 40 μM concentration of KE12 peptides is much above the peptide concentration in cell culture media, so the data presented here indicated the non-toxicity of zwitterionic peptides to the cell environment.

For the cell viability test, a batch process was conducted with 3 different KE12 conditions on IgG expressing CHO cell line to study the cytotoxicity of KE12. The study found that samples treated with various concentrations of KE12 had no significant difference from the control samples in cell growth, viability, and titer production during the entirety of the batch process.

### CONCLUSION

On this basis, we designed several zwitterionic peptides based on the different number of charged groups and linker designs and studied their antifouling performance. Our results show that increasing the number of charged groups and hydrophilicity could improve the antifouling performance by binding more water, which proves the generally accepted water shell hypothesis. Zwitterionic peptides can be successfully attached to the gold substrate and PES membrane with a tunable design of the peptide sequence and modification chemistry. SEM imaging studies indicate the pore size and functionality of the membrane are not affected by the modification process. The protein adsorption tests in different testing environments indicated that zwitterionic peptides have an antifouling effect in a protein environment, cell culture environment, and lysed cell extreme conditions. This antifouling performance can be further improved by increasing the zwitterionic peptide grafting density and we figured out the optimal peptide grafting conditions, which can be further applied to protein purification or membrane separation industry to prolong the membrane lifetime and reduce the cost. Altogether, this study provides useful antifouling membrane modification insights, which have not been studied before, and validates the key determinants of the antifouling properties of zwitterionic peptides modified substrates in membrane separation applications.

While the foregoing disclosure has been described in some detail by way of illustration and example for purposes of clarity and understanding, it will be clear to one of ordinary skill in the art from a reading of this disclosure that various changes in form and detail can be made without departing from the true scope of the disclosure and may be practiced within the scope of the appended claims. For example, all the methods, devices, systems, computer readable media, and/or component parts or other aspects thereof can be used in various combinations. All patents, patent applications, websites, other publications or documents, and the like cited herein are incorporated by reference in their entirety for all purposes to the same extent as if each individual item were specifically and individually indicated to be so incorporated by reference.

What is claimed is:

1. An antifouling filtration membrane, comprising:
a membrane substrate; and,
an antifouling coating disposed on at least one surface of the membrane substrate, wherein the antifouling coating comprises a plurality of zwitterionic molecules or moieties at a density sufficient to form a hydration shell when an aqueous input composition contacts the antifouling coating and wherein the hydration shell substantially prevents fouling components in the aqueous input composition from adsorbing on the membrane substrate.

2. The antifouling filtration membrane of claim 1, wherein the hydration shell substantially prevents fouling components in the aqueous input composition from adsorbing on the membrane substrate while substantially permitting target permeate molecules in the aqueous input composition to flow through the membrane substrate.

3. The antifouling filtration membrane of claim 1, wherein the zwitterionic molecules or moieties comprise at least one zwitterionic pair of amino acid residues.

4. The antifouling filtration membrane of claim 1, wherein at least one zwitterionic molecule or moiety comprises a structure that is selected from the group consisting of: KE-8, MKE-12, and KE-12.

5. The antifouling filtration membrane of claim 1, wherein the plurality of zwitterionic molecules or moieties comprises a plurality of zwitterionic peptides having a grafting density on the surface of the membrane substrate of at least about 0.05 chains/nm².

6. The antifouling filtration membrane of claim 1, wherein the antifouling filtration membrane adsorbs less than about 1.5 μg² of an IgG protein/cm² of the membrane substrate when the membrane substrate is exposed to the IgG protein.

7. The antifouling filtration membrane of claim 1, wherein dopamine methacrylamide is conjugated to the surface of the membrane substrate.

8. The antifouling filtration membrane of claim 1, wherein the membrane substrate comprises poly(ethersulfone) (PES) and wherein the plurality of zwitterionic molecules or moieties comprise KE-12 structures.

9. A system, comprising:
a filtration module that comprises an inlet port, an outlet port, and an antifouling filtration membrane, wherein the antifouling filtration membrane comprises:
a membrane substrate; and
an antifouling coating disposed on at least one surface of the membrane substrate, wherein the antifouling coating comprises a plurality of zwitterionic molecules or moieties at a density sufficient to form a hydration shell when an aqueous input composition contacts the antifouling coating and wherein the hydration shell substantially prevents fouling components in the aqueous input composition from adsorbing on the membrane substrate;
an storage container configured to contain the aqueous input composition, which storage container fluidly communicates with the inlet port of the filtration module;
a retentate fluid circuit that fluidly communicates with the outlet port of the filtration module;
a fluid conveyance mechanism operably connected to the filtration module, the storage container, and/or the retentate fluid circuit; and,
a controller operably connected, or connectable, to the fluid conveyance mechanism, which controller comprises, or is capable of accessing, computer readable media comprising non-transitory computer-executable instructions, which when executed by at least one electronic processor perform at least:
conveying the aqueous input composition into the filtration module through the inlet port from the storage container when the storage container contains the aqueous input composition.

10. The system of claim 9, wherein the retentate fluid circuit further fluidly communicates with the storage container such that retentate from the aqueous input composition is conveyed back to the storage container from the outlet port when the aqueous input composition is conveyed into the filtration module through the inlet port.

11. The system of claim 9, wherein at least one zwitterionic molecule or moiety comprises a structure that is selected from the group consisting of: KE-8, MKE-12, and KE-12.

12. The system of claim 9, wherein the plurality of zwitterionic molecules or moieties comprises a plurality of zwitterionic peptides having a grafting density on the surface of the membrane substrate of at least about 0.05 chains/nm².

13. The system of claim 9, wherein the antifouling filtration membrane adsorbs less than about 1.5 μg² of an IgG protein/cm of the membrane substrate when the membrane substrate is exposed to the IgG protein.

14. The system of claim 9, wherein the membrane substrate comprises poly(ethersulfone) (PES) and wherein the plurality of zwitterionic molecules or moieties comprise KE-12 structures.

15. A method of separating target permeate molecules from retentate molecules in an aqueous input composition, the method comprising contacting the aqueous input composition with an antifouling filtration membrane that comprises a membrane substrate, and an antifouling coating disposed on at least one surface of the membrane substrate, wherein the antifouling coating comprises a plurality of zwitterionic molecules or moieties at a density sufficient to form a hydration shell when the aqueous input composition contacts the antifouling coating, wherein the hydration shell substantially prevents fouling components in the aqueous input composition from adsorbing on the membrane substrate while substantially permitting the target permeate molecules in the aqueous input composition to flow through the membrane substrate, and wherein the antifouling filtration membrane substantially prevents the retentate molecules in the aqueous input composition from flowing through the membrane substrate, thereby separating the target permeate molecules from the retentate molecules in the aqueous input composition.

16. The method of claim 15, wherein at least one zwitterionic molecule or moiety comprises a structure that is selected from the group consisting of: KE-8, MKE-12, and KE-12.

17. The method of claim 15, wherein the plurality of zwitterionic molecules or moieties comprises a plurality of zwitterionic peptides having a grafting density on the surface of the membrane substrate of at least about 0.05 chains/nm².

18. The method of claim 15, wherein the antifouling filtration membrane adsorbs less than about 1.5 μg² of an IgG protein/cm of the membrane substrate when the membrane substrate is exposed to the IgG protein.

19. The method of claim 15, wherein the membrane substrate comprises poly(ethersulfone) (PES) and wherein the plurality of zwitterionic molecules or moieties comprise KE-12 structures.

20. The method of claim 15, wherein the KE-12 structures are conjugated to the membrane substrate via dopamine methacrylamide.
